(19) United States
(12) Patent Application Publication
(10) Pub. No.: US 2018/0127290 A1
(43) Pub. Date: May 10, 2018

(54) SEPARATION OF SUSPENSIONS OF SOLIDS EMPLOYING WATER SOLUBLE POLYMER AND A CHEMICAL AGENT

(71) Applicant: BASF SE, Ludwigshafen am Rhein (DE)

(72) Inventors: Lewis Utting, Darlinghurst (AU); Stephen John Adkins, Cleckheaton (GB)

(73) Assignee: BASF SE, Ludwigshafen am Rhein (DE)

(21) Appl. No.: 15/569,843

(22) PCT Filed: Apr. 27, 2016
(86) PCT No.: PCT/IB2016/052371

§ 371 Date: Oct. 27, 2017

(30) Foreign Application Priority Data
Apr. 30, 2015 (EP) 15166009.9

(51) Int. Cl. C02F 1/56; B01D 21/01; C02F 11/06; C02F 11/14

(52) U.S. Cl. CPC C02F 1/56; B01D 21/01; C10G 1/00; C02F 11/14; C02F 11/06

(57) ABSTRACT

A process of separating a suspension of particulate solids dispersed in an aqueous liquid into a liquid portion and a solids portion by transferring the suspension by flowing it to a deposition area, subjecting the suspension to a treatment system during the transfer, and at the deposition area allowing the suspension to separate into the liquid portion and the solids portion, in which the treatment system contains
(a) a water soluble polymer; and
(b) a chemical agent selected from at least one of an oxidising agent, a reducing agent, and/or a free radical agent.
   The treatment system enables a solids portion to be deposited and formed by an initial rigidification of the solids accompanied by an initial release of fluid, followed by a further consolidation of the rigidified solids with the further release of liquid.

The present invention relates to a process of separating a suspension comprising particulate solids dispersed in an aqueous liquid into a liquid portion and a solids portion. The suspension is for instance a mineral material, especially waste mineral slurries. This invention is particularly suitable for the disposal of tailings and other waste material resulting from mining and mineral processing operations.

Processes of treating mineral ores or oil sands in order to extract mineral values or in the case of oil sands to extract hydrocarbons will normally result in waste material. Often the waste material consists of an aqueous slurry or sludge comprising particulate mineral material, for instance clay, shale, sand, grit, oil sand tailings, metal oxides etc. admixed with water.

In some cases the waste material such as mine tailings can be conveniently disposed of in an underground mine to form backfill. Generally backfill waste comprises a high proportion of coarse large sized particles together with other smaller sized particles and is pumped into the mine as slurry where it is allowed to dewater leaving the sedimented solids in place. It is common practice to use flocculants to assist this process by flocculating the fine material to increase the rate of sedimentation. However, in this instance, the coarse material will normally sediment at a faster rate than the flocculated fines, resulting in a heterogeneous deposit of coarse and fine solids.

For other applications it may not be possible to dispose of the waste in a mine. In these instances, it is common practice to dispose of this material by pumping the aqueous slurry to lagoons, ponds, heaps or stacks and allowing it to dewater gradually through the actions of sedimentation, drainage and evaporation.

For example in oil sands processing, the ore is processed to recover the hydrocarbon fraction, and the remainder, including both process material and the gangue, constitutes the tailings that are to be disposed of. In oil sands processing, the main process material is water, and the gangue is mostly sand with some silt and clay. Physically, the tailings consist of a solid part (sand tailings) and a more or less fluid part (sludge). The most satisfactory place to dispose of these tailings is, of course, in the existing excavated hole in the ground. It turns out, however, that the sand tailings alone from the one cubic foot of ore occupy just about one cubic foot. The amount of sludge is variable, depending on ore quality and process conditions, but average about 0.3 cubic feet. The tailings simply will not fit back into the hole in the ground.

There is a great deal of environmental pressure to minimise the allocation of new land for disposal purposes and to more effectively use the existing waste areas. One method is to load multiple layers of waste onto an area to thus form higher stacks of waste. However, this presents a difficulty of ensuring that the waste material can only flow over the surface of previously rigidified waste within acceptable boundaries, is allowed to rigidify to form a stack, and that the waste is sufficiently consolidated to support multiple layers of rigidified material, without the risk of collapse or slip. Thus the requirements for providing a waste material with the right sort of characteristics for stacking is altogether different from those required for other forms of disposal, such as back-filling within a relatively enclosed area.

In a typical mineral or oil sands processing operation, waste solids are separated from solids that contain mineral values in an aqueous process. The aqueous suspension of waste solids often contains clays and other minerals, which waste solids are usually referred to as tailings. These solids are often concentrated by a flocculation process in a thickener to give a higher density underflow and to recover some of the process water. It is usual to pump the underflow to a surface holding area, often referred to as a tailings pit or dam or more usually a tailings pond in the case of oil sands. Once deposited at this surface holding area, water will continue to be released from the aqueous suspension resulting in further concentration of the solids over a period of time. Once a sufficient volume of water has been collected this is usually pumped back to the mineral or oil sands processing plant.

The tailings pond or dam is often of limited size in order to minimise the impact on the environment. In addition, providing larger tailings ponds is expensive due to the high costs of earth moving and the building of containment walls. These ponds tend to have a gently sloping bottom which allows any water released from the solids to collect in one area and which can then be pumped back to the plant. A problem that frequently occurs is when fine particles of solids are carried away with the run-off water, thus contaminating the water and having a detrimental impact on subsequent uses of the water.

In many mineral and oil sands processing operations, for instance a mineral sands beneficiation process, it is also common to produce a second waste stream comprising of mainly coarse (>0.1 mm) mineral particles. It is desirable to dispose of the coarse and fine waste particles as a homogeneous mixture as this improves both the mechanical properties of the dewatered solids, reducing the time and the cost eventually required to rehabilitate the land. However, this is not usually possible because even if the coarse waste material is thoroughly mixed into the aqueous suspension of fine waste material prior to deposition in the disposal area, the coarse material will settle much faster than the fine material resulting in banding within the dewatered solids. Furthermore, when the quantity of coarse material to fine material is relatively high, the rapid sedimentation of the coarse material may produce excessive beach angles which promote the run off of aqueous waste containing high proportions of fine particles, further contaminating the recovered water. As a result, it is often necessary to treat the coarse and fine waste streams separately, and combine once the dewatering process is complete.

Generally oil sands tailings ponds are located within close proximity of the oil sands mining and extraction operations in order to facilitate pipeline transportation, discharging and management of the tailings. A tailings pond may be contained within a retaining structure which may be referred to as a dyke structure. A suitable dyke structure may generally be constructed by placing the sand fraction of the tailings within cells or on beaches. Tailings streams initially discharged into the ponds may have low densities and solids contents, for instance around 0.5 to 10% by weight.

In an oil sands tailings pond, the process water, unrecovered hydrocarbons and minerals settle naturally to form different strata. The upper stratum can be predominantly water that maybe recycled as process water to the extraction process. The lower stratum can contain settled residual hydrocarbon and minerals which are predominantly fines. It is usual to refer to this lower stratum as “mature fine tailings” (MFT). It is known that mature fine tailings consolidate slowly before settling into a consolidated solid mass. Consequently mature fine tailings and the ponds containing them are a major challenge to tailings management and the mining industry.

In addition, aqueous suspensions waste solids from mining and mineral processing operations including mining tailings, such as MFT, held in ponds of holding areas may also contain coarse debris. The type and composition of this coarse debris depends on the origin of the suspension. In the case of MFT the coarse debris tends to be of different sizes, shapes and chemical compositions. For instance, MFT may include coarse debris such as biomass, such as wood or other plant material; petrified matter; solids having a density low enough to float at or near the surface of the pond; glass; plastic; metal; bitumen globules; or mats. The coarse debris found in other mining tailings may include similar debris as in the case of MFT, with the exception of bitumen materials and may also include other debris materials such as lumps of ore or other masses depending on the geology of the ore mine, the ore extraction processing technique, or the location of the tailings pond.

It is known that aqueous suspensions and mining tailings, such as MFT, may be dewatered and solidified through the action chemical treatments. A typical chemical treatment employs the addition of chemical flocculating agents to bring about flocculation and be so formed flocculated suspensions can be subjected to dewatering.

It is well known to concentrate these oil sand tailings in a thickener to give a higher density underflow and to recover some of the process water as mentioned above.

For example, Xu. Y et al, Mining Engineering, November 2003, p. 33-39 describes the addition of anionic flocculants to the oil sand tailings in the thickener before disposal.

The underflow can be disposed of and/or subjected to further drying for subsequent disposal in an oil sand tailings stacking area.

In the Bayer process for recovery of alumina from bauxite, the bauxite is digested in an aqueous alkaline liquor to form sodium aluminate which is separated from the insoluble residue. This residue consists of both sand, and fine particles of mainly ferric oxide. The aqueous suspension of the latter is known as red mud.

After the primary separation of the sodium aluminate solution from the insoluble residue, the sand (coarse waste) is separated from the red mud. The supernatant liquor is further processed to recover aluminate. The red mud is then washed in a plurality of sequential washing stages, in which the red mud is contacted by a wash liquor and is then flocculated by addition of a flocculating agent. After the final wash stage the red mud slurry is thickened as much as possible and then disposed of. Thickening in the context of this specification means that the solids content of the red mud is increased. The final thickening stage may comprise settlement of flocculated slurry only, or sometimes, includes a filtration step. Alternatively or additionally, the mud may be subjected to prolonged settlement in a lagoon. In any case, this final thickening stage is limited by the requirement to pump the thickened aqueous suspension to the disposal area.

The mud can be disposed of and/or subjected to further drying for subsequent disposal on a mud stacking area. To be suitable for mud stacking the mud should have a high solids content and, when stacked, should not flow but should be relatively rigid in order that the stacking angle should be as high as possible so that the stack takes up as little area as possible for a given volume. The requirement for high solids content conflicts with the requirement for the material to remain pumpable as a fluid, so that even though it may be possible to produce a mud having the desired high solids content for stacking, this may render the mud unpumpable.

The sand fraction removed from the residue is also washed and transferred to the disposal area for separate dewatering and disposal.

EP-A-388108 describes adding a water-absorbent, water-insoluble polymer to a material comprising an aqueous liquid with dispersed particulate solids, such as red mud, prior to pumping and then pumping the material, allowing the material to stand and then allowing it to rigidify and become a stackable solid. The polymer absorbs the aqueous liquid of the slurry which aids the binding of the particulate solids and thus solidification of the material. However this process has the disadvantage that it requires high doses of absorbent polymer in order to achieve adequate solidification. In order to achieve a sufficiently rigidified material it is often necessary to use doses as high as 10 to 20 kilograms per tonne of mud. Although the use of water swellable absorbent polymer to rigidify the material may appear to give an apparent increase in solids, the aqueous liquid is in fact held within the absorbent polymer. This presents the disadvantage that as the aqueous liquid has not actually been removed from the rigidified material and under certain conditions the aqueous liquid could be desorbed subsequently and this could risk re-fluidisation of the waste material, with the inevitable risk of destabilising the stack.

WO-A-96/05146 describes a process of stacking an aqueous slurry of particulate solids which comprises admixing an emulsion of a water-soluble polymer dispersed in a continuous oil phase with the slurry. Preference is given to diluting the emulsion polymer with a diluent, and which is preferably in a hydrocarbon liquid or gas and which will not invert the emulsion.

WO-A-0192167 describes a process where a material comprising a suspension of particulate solids is pumped as a fluid and then allowed to stand and rigidify. The rigidification is achieved by introducing into the suspension particles of a water soluble polymer which has an intrinsic viscosity of at least 3 dl/g. This treatment enables the material to retain its fluidity as being pumped, but upon standing causes the material to rigidify. This process has the benefit that the concentrated solids can be easily stacked, which minimises the area of land required for disposal. The process also has the advantage over the use of cross linked water absorbent polymers in that water from the suspension is released rather than being absorbed and retained by the polymer. Very efficient release of water and convenient storage of the waste solids is achieved by this process, especially when applied to a red mud underflow from the Bayer alumina process.

WO2004/060819 describes a process in which material comprising an aqueous liquid with dispersed particulate solids is transferred as a fluid to a deposition area, then allowed to stand and rigidify, and in which rigidification is improved whilst retaining the fluidity of the material during transfer, by combining with the material an effective rigidifying amount of an aqueous solution of a water-soluble polymer. Also described is a process in which dewatering of the particulate solids is achieved.

Canadian patent application 2512324 describes a process for the rigidification of a suspension which is or comprises oil sand tailings. The process involves transferring the suspension as a fluid to a deposition area in which an effective rigidifying amount of an aqueous solution of a water-soluble polymer is combined with the suspension during transfer and then allowing the so treated suspension to stand and rigidify. The rigidification is improved whilst retaining the fluidity of the material during transfer. The process was particularly suited to the treatment of tailings as they are produced from the oil sands processing operation.

The suspensions which are treated in accordance with the present invention may be derived from any one of numerous mineral processing operations. Generally such suspensions may be suspensions which have been thickened in a gravimetric thickener vessel and subsequently removed as underflow. Various processes are known for providing such thickened suspensions. Typically such processes may involve the application of flocculants to the gravimetric thickener vessel to bring about flocculation of the solids which settle at the bottom of the vessel. In addition it is known to apply agents such as free radical agents, oxidising agents, enzymes and radiation in such vessels so as to improve the mobility of the thickened suspension by reducing the yield stress, for instance as described in WO 2007 082797.

A problem which can occur is that deposited particulate solids, for example mineral sands tailings, coal fines tailings, oil sands tailings, red mud, which have been disposed in a deposition area may appear to be consolidated and effectively rigid but in some cases may contain unreleased liquid. In certain cases this liquid may contribute to reducing the stability of such surface deposited particulate solids. In some cases this may lead to unforeseen movement or slipping of at least some of the particulate solids.

It is an objective of the present invention to provide a process which improves upon the aforementioned processes of depositing particulate solids, especially waste mineral particulate solids such as mineral sands tailings, coal fines tailings, oil sands tailings, red mud or tailings from other mineral processing operations. Further, it is an objective to achieve efficient deposition of such particulate solids which can be adequately consolidated and formed into a rigid mass in a way which reduces the risk of any subsequent free movement or slip of deposited solids.

The present invention relates to a process of separating a suspension comprising particulate solids dispersed in an aqueous liquid into a liquid portion and a solids portion comprising the steps of transferring the suspension by flowing it to a deposition area, subjecting the suspension to a treatment system during the transfer, at the deposition area allowing the suspension to separate into the liquid portion and the solids portion, wherein the treatment system comprises,
(a) a water soluble polymer; and
(b) a chemical agent selected from at least one of an oxidising agent, a reducing agent, and/or a free radical agent.

The inventors discovered that the process of the present invention achieves the aforesaid objectives. Further, the inventors found that the particulate solids that have been deposited more readily exhibited an increase in yield stress. In addition, a greater degree of separation of predominantly liquid and predominantly solids portions can be achieved.

By liquid portion we mean that the liquid may contain a relatively small amount of solid particles dispersed therein. The amount of solids present in the liquid portion tends to vary depending upon the type of initial suspension, including the type of particulate solids, the range of particles sizes and particle size distribution but in general may be less than 0.5% weight/weight, often less than 0.1% weight/weight, typically less than 0.5% weight/weight, and desirably even as low as substantially 0%. By solids portion we mean that the portion comprises mostly particulate solids but may contain residual entrained aqueous liquid. Typically the amount of liquid in the initial separated solids portion also tends to depend on the type of initial suspension, including the type of particulate solids, the range of particles sizes and particle size distribution but typically the liquid content of the initially separated solids may be reduced by between 1 and 99% by weight, suitably between 10 and 80% by weight. Nevertheless the solids portion should desirably remain in the deposition area and the amount of liquid contained therein will tend to reduce over time. This reduction in liquid content can be achieved more rapidly and to a higher degree than other known processes of depositing particulate solids in deposition areas.

The separated solids portion should form as a deposit of particulate solids in the deposition area from which there should be an initial rapid release of liquid from the treated suspension in the deposition area which would be termed rigidification. The rapid release of liquid tends to occur as the velocity of the flow of the treated suspension reduces and becomes stationary. This may be followed by a further release of liquid as the rigidified solids undergo compression and consolidate.

Rigidification is a term that refers to a networked structure of particulate solids. Compared with settling or sedimentation, rigidification is faster, produces more recovered water and results in chemically bonded tailings that occupy a smaller surface area, which is more quickly rehabilitated. Rigidified tailings are also less likely to spread laterally after deposition enabling more efficient land use; and would more rapidly form a solid structure in the form of a beach or stack; and have a greater yield stress when deposited, with increased uniformity or homogenity of coarse and fine particles. Further by reason of its heaped geometry as a beach or stack such rigidified material would result in downward compression forces, driving water out of the stack and more rapid release of water, with better clarity.

The present invention brings about a further improvement to the rigidified deposit by causing a further consolidation of the rigidified solids thereby enabling further release of liquid and an increased dryness of the deposited solids. Suitably by further consolidating the rigidified solids the liquid content may then be further reduced by between 1 and 99% by weight, for instance, between 10 and 80% by weight.

Preferably the water soluble polymer can be added to the suspension of particulate solids in the form of an aqueous solution.

The polymer solution may consist wholly or partially of water-soluble polymer. Thus the polymer solution may comprise a blend of cross-linked polymer and water soluble polymer, provided sufficient of the polymer is in solution or behaves as though it is in solution to bring about separation of the suspension into the solids portion and liquid portion at the deposition area, including rigidification.

This may be a physical blend of swellable polymer and soluble polymer or alternatively is a lightly cross-linked polymer for instance as described in EP202780. Although the polymeric particles may comprise some cross-linked polymer it is essential to the present invention that a significant amount of water soluble polymer is present. When the polymeric particles comprise some swellable polymer it is desirable that at least 80% of the polymer is water-soluble.

Preferably the polymer comprises polymer which is wholly or at least substantially water soluble. The water soluble polymer may be branched by the presence of branching agent, for instance as described in WO-A-9829604, for instance in claim 12, or alternatively the water soluble polymer is substantially linear.

Preferably the water soluble polymer is of moderate to high molecular weight. Desirably it should have an intrinsic viscosity of at least 1 dl/g, typically at least 3 dl/g and generally at least 4.5 or 5 or 6 dl/g, although the polymer may be of significantly high molecular weight and exhibit an intrinsic viscosity of 25 dl/g or 30 dl/g or even higher. Preferably the polymer will have an intrinsic viscosity in the range of from 5 to 30 dl/g, for instance, from 8 dl/g to 25 dl/g, more preferably from 11 dl/g or 12 dl/g to 18 dl/g or 20 dl/g. Alternatively, it may be preferred that the polymer as an intrinsic viscosity from 3 to 12 dl/g, for instance, from 5 to 10 dl/g.

Intrinsic viscosity of polymers may be determined by preparing an aqueous solution of the polymer (0.5-1% w/w) based on the active content of the polymer. 2 g of this 0.5-1% polymer solution is diluted to 100 ml in a volumetric flask with 50 ml of 2M sodium chloride solution that is buffered to pH 7.0 and the whole is diluted to the 100 ml mark with deionised water. The intrinsic viscosity of the polymers is measured using a Number 1 suspended level viscometer at 25° C. in 1M buffered salt solution.

Desirably the water soluble polymers have a solubility in water of at least 5 g/100 cc at 25° C.

The water soluble polymer may be a natural polymer, for instance polysaccharides such as starch, guar gum or dextran, or a semi-natural polymer such as carboxymethyl cellulose or hydroxyethyl cellulose. Preferably the polymer is synthetic and preferably it is formed from an ethylenically unsaturated water-soluble monomer or blend of monomers.

The water soluble polymer may be cationic, non-ionic, amphoteric, or anionic. The polymers may be formed from any suitable water-soluble monomers. Typically the water soluble monomers have a solubility in water of at least 5 g/100 cc at 25° C.

Particularly preferred anionic polymers are formed from monomers selected from ethylenically unsaturated carboxylic acid and sulphonic acid monomers. One preferred group of polymers is selected from (meth) acrylic acid, allyl sulphonic acid and 2-acrylamido-2-methyl propane sulphonic acid (ATBS), and/or their salts, optionally in combination with non-ionic co-monomers, preferably selected from (meth) acrylamide, hydroxy alkyl esters of (meth) acrylic acid, N-vinyl pyrrolidone, vinyl amides (e.g. vinyl formamide), and vinyl carboxylates (e.g. vinyl acetate). The salts of (meth) acrylic acid, allyl sulphonic acid and 2-acrylamido-2-methyl propane sulphonic acid may include alkaline metal salts such as the potassium, sodium or lithium salts or may include the alkaline earth metal salts such as beryllium, magnesium or calcium. Other suitable salts include the ammonium or alkyl ammonium salts. Particularly desirable anionic polymers include anionic polyacrylamides. Preferably, such anionic polyacrylamides may be copolymers of acrylamide with sodium acrylate, or copolymers of acrylamide with calcium acrylate. By referring to calcium acrylate, we also include calcium diacrylate.

Generally non-ionic polymers are formed from ethylenically unsaturated monomers. A suitable group of polymers includes polymers of one or more of the monomers (meth) acrylamide, hydroxy alkyl esters of (meth) acrylic acid, N-vinyl pyrrolidone, vinyl amides (e.g. vinyl formamide), and vinyl carboxylates (e.g. vinyl acetate). Other non-ionic polymers include for instance polyethylene oxide (PEO).

Typically cationic polymers are formed from ethylenically unsaturated monomers. A further suitable group of polymers includes polymers of at least one of the monomers dimethyl amino ethyl (meth) acrylate-methyl chloride, (DMAEA.MeCl) quat, diallyl dimethyl ammonium chloride (DADMAC), trimethyl amino propyl (meth) acrylamide chloride (ATPAC) optionally in combination with non-ionic co-monomers, preferably selected from (meth) acrylamide, hydroxy alkyl esters of (meth) acrylic acid, N-vinyl pyrrolidone, vinyl amides (e.g. vinyl formamide), vinyl carboxylates (e.g. vinyl acetate).

In some instances, it has been found advantageous to separately add combinations of polymer types. Thus an aqueous solution of an anionic, cationic or non-ionic polymer may be added to the above mentioned material first, followed by a second dose of either a similar or different water soluble polymer of any type. It may be desirable to use blends of different polymers. Desirably this includes blends of polyethylene oxide (PEO) and anionic polyacrylamide.

In the invention, the water soluble polymer may be formed by any suitable polymerisation process. The polymers may be prepared for instance as gel polymers by solution polymerisation, water-in-oil suspension polymerisation or by water-in-oil emulsion polymerisation. When preparing gel polymers by solution polymerisation the initiators are generally introduced into the monomer solution.

Optionally a thermal initiator system may be included. Typically a thermal initiator would include any suitable initiator compound that releases radicals at an elevated temperature, for instance azo compounds, such as azo-bis-isobutyronitrile. The temperature during polymerisation should rise to at least 70° C. but preferably below 95° C. Alternatively polymerisation may be effected by irradiation (ultra violet light, microwave energy, heat etc.) optionally also using suitable radiation initiators. Once the polymerisation is complete and the polymer gel has been allowed to cool sufficiently the gel can be processed in a standard way by first comminuting the gel into smaller pieces, drying to the substantially dehydrated polymer followed by grinding to a powder. Alternatively polymer gels may be supplied in the form of polymer gels, for instance as neutron type gel polymer logs.

Such polymer gels may be prepared by suitable polymerisation techniques as described above, for instance by irradiation. The gels may be chopped to an appropriate size as required and then on application mixed with the material as partially hydrated water soluble polymer particles. The polymers may be produced as beads by suspension polymerisation or as a water-in-oil emulsion or dispersion by water-in-oil emulsion polymerisation, for example according to a process defined by EP-A-150933, EP-A-102760 or EP-A126528.

Alternatively the water soluble polymer may be provided as a dispersion in an aqueous medium. This may for instance be a dispersion of polymer particles of at least 20 microns in an aqueous medium containing an equilibrating agent as given in EP-A-170394. This may for example also include aqueous dispersions of polymer particles prepared by the polymerisation of aqueous monomers in the presence of an aqueous medium containing dissolved low IV polymers such as poly diallyl dimethyl ammonium chloride and optionally other dissolved materials for instance electrolyte and/or multi-hydroxy compounds e. g. polyalkylene glycols, as given in WO-A9831749 or WO-A-9831748.

The aqueous solution of water-soluble polymer is typically obtained by dissolving the polymer in water or by diluting a more concentrated solution of the polymer. Generally solid particulate polymer, for instance in the form of powder or beads, is dispersed in water and allowed to dissolve with agitation. This may be achieved using conventional make up equipment. Desirably, the polymer solution can be prepared using the Auto Jet Wet (trademark) supplied by BASF. Alternatively, the polymer may be supplied in the form of a reverse phase emulsion or dispersion which can then be inverted into water.

When the polymer is added as an aqueous solution the aqueous polymer solution may be added in any suitable concentration. It may be desirable to employ a relatively concentrated solution, for instance up to 10% or more based on weight of polymer in order to minimise the amount of water introduced into the material. Usually though it will be desirable to add the polymer solution at a lower concentration to minimise problems resulting from the high viscosity of the polymer solution and to facilitate distribution of the polymer throughout the suspension of particulate solids. The polymer solution can be added at a relatively dilute concentration, for instance as low as 0.01% by weight of polymer. Typically the polymer solution will normally be used at a concentration between 0.05 and 5% by weight of polymer. Preferably the polymer concentration will be the range 0.1% to 2 or 3%. More preferably the concentration will range from 0.25% to about 1 or 1.5%.

Suitable doses of water soluble polymer (calculated on the basis of active polymer) range from 10 grams to 10,000 grams per tonne of suspension solids. Generally the appropriate dose can vary according to the particular material and material solids content. Preferred doses are in the range 30 to 3,000 grams per tonne, while more preferred doses are in the range of from 60 to 200 or 400 grams per tonne.

The chemical agent according to the invention is selected from the group consisting of oxidising agents, reducing agents and free radical producing agents.

Suitably the oxidising agent may be selected from perchlorates, hypochlorites, perbromates, hypobromites, periodates, hypoiodites, perborates, percarbonates, persulphates, peracetates, ozone and peroxides. The use of peroxides, ozone, hypochlorites, peracetates, perborates, percarbonate and persulphates have been found to be particularly effective for oxidizing purposes.

Preferred oxidising agents for use in present invention are peroxides and ozone. A particularly preferred peroxide is hydrogen peroxide. Suitably the hydrogen peroxide will be in an aqueous solution containing at least 1% hydrogen peroxide on weight basis, typically at least 5% and often at least 10% and often at least 20%, preferably at least 30% as much as 50 or 60% or more. When ozone is used it may be used as a gas by direct injection of the gas although it is preferred that the ozone is in the form of ozone water. Typically the ozone water would have a concentration of at least 0.1 ppm and usually at least 1 ppm. The concentration of ozone in the ozone water may be as much as 1000 ppm or more (on the basis of weight of ozone per volume of water) but usually effective results are obtained at lower concentrations, such as up to 500 ppm or even up to 100 ppm. The ability to achieve a particular concentration of ozone in water will often depend upon the equipment used to combine the ozone with the water, the temperature of the water and ozone and the pressure. High concentrations may sometimes be achievable in highly pressurised systems especially at lower temperatures. Often the concentration will be in the range of between 5 ppm and 50 ppm, for instance between 10 ppm and 40 ppm, especially between 20 ppm and 30 ppm.

The amount of at least one oxidising agent will vary according to the specific process conditions, the type of particulate solids in the suspension and water soluble polymer. The oxidising agent preferably should be introduced at a dose in an amount of at least 1 ppm based on weight of agent on volume of the aqueous suspension. The oxidising agent can be effective at low levels for example between 1 and 10 ppm. Generally the oxidising agent will be added in an amount of from at least 100 ppm and in some cases may be at least 1000 ppm based on weight of oxidising agent on the volume of the aqueous suspension of solid particles. In some cases it may be desirable to add significantly higher levels of the oxidising agent, for instance as much as 40,000 or 50,000 ppm or higher. Effective doses usually will be in the range between 150 and 20,000 ppm, especially between 1000 and 15,000 ppm.

When the active agent is a reducing agent it may for instance be sulphites, bisulphites, phosphites, hypophosphites and phosphorous acid etc. These may be provided as the ammonium or alkali metal salts such as sodium or potassium salts.

By addition of free radical agents we mean the inclusion of anything which form or generate free radicals in situ. Suitable free radical agents include chemical compounds selected from the group consisting of ferrous ammonium sulphate, ceric ammonium nitrate etc. Furthermore, any of the compounds listed as either oxidising agents or reducing agents may also be regarded as free radical agents.

The amount of at least one reducing agent or at least one free radical agent desirably may be in the same ranges as that of the oxidising agent mentioned above.

The treatment system should be applied to the suspension of particulate solids during transfer as it flows to the deposition area. This can be achieved by addition of both the water soluble polymer and the chemical agent. The water soluble polymer and the chemical agent may be added to the suspension sequentially but preferably they are added substantially simultaneously.

When water-soluble polymer and chemical agent of the treatment system are added sequentially the chemical agent may be added to the suspension of particulate solids and then the water-soluble polymer may be added. Alternatively, the water soluble polymer may be added to the suspension of particulate solids before addition of the chemical agent. Desirably, where the chemical agent is added before the water-soluble polymer the chemical agent should be added at a point which is less than 10 m before the point at which the water-soluble polymer is added. In such cases it is preferred that the addition point of the chemical agent is within 5 m, more preferably no more than 2 m, before the addition point of the water-soluble polymer. In the case where the water-soluble polymer is added before the addition point of the chemical agent, the chemical agent may be added to the suspension at any point after the addition of the water-soluble polymer provided that it is during the transfer. It is believed that provided that the chemical agent is added during transfer the suspension of particulate solids should still be flowing and therefore would have the opportunity to distribute throughout the suspension. Nevertheless in the case where the water-soluble polymer is added before the chemical agent it is preferred that the chemical agent is added not more than 50 m after the addition point of the water-soluble polymer. In such cases, it is preferred that the addition point of the chemical agent is within 25 m, desirably within 10 m, more desirably within 5 m and suitably no more than 2 m after the addition point of the water-soluble polymer.

Preferably, the water-soluble polymer and chemical agent are both added the suspension of particulate solids substantially simultaneously. By substantially simultaneously we mean that both the water-soluble polymer and chemical agent are added to the suspension of particulate solids at the same point or the addition points of the water-soluble polymer and chemical agent are less than 2 m, preferably less than 1.5 m or less than 1 m, apart from each other.

In general the suspension of particulate solids would normally be transferred to the deposition area by the employment of at least one pumping stage. In some cases it may be desirable to add the treatment system, comprising addition of both of the water-soluble polymer and the chemical agent, prior to a pumping stage. This may allow the treatment system to fully integrate into the suspension of particulate solids. Alternatively, it may be desirable to add one of the components of the treatment system, for instance either the water-soluble polymer or the chemical agent before a pumping stage and the other component after a pumping stage. Preferably, the treatment system, including both the water-soluble polymer and the chemical agent, is added after a pumping stage. In the case where there is only one pumping stage it is preferred that the treatment system, including both the water-soluble polymer and the chemical agent, is added after that pumping stage. In the case where there is more than one pumping stage employed to transfer suspension of particulate solids to the deposition area, it is more preferred that the treatment system, comprising both the water-soluble polymer and chemical agent, is added after the last pumping stage. This is particularly the case where the water-soluble polymer is added to the suspension of particulate solids in the form of an aqueous solution.

Typically the suspension of particulate solids is transferred by pumping along a conduit to a deposition area. The conduit can be any convenient means for transferring the suspension to the deposition area and may for instance be a pipeline or even a trench. The deposition area may be or may be adjacent to a tailings dam or lagoon.

Normally the suspension of particulate solids would be transferred continuously to the deposition area i.e. without any interruption of the flow. However, in some cases it may be desirable to transfer the suspension first to a holding vessel before being transferred to the deposition area.

Suitably the suspension of particulate solids is transferred to the deposition area through a conduit, for instance a pipeline. Normally such a conduit, for instance pipeline, would have an outlet from which the suspension of particulate solids exits as it flows to the deposition area. Typically the outlet of the conduit, for instance pipeline, is at the deposition area or may be close to the deposition area, for instance less than 20 m, usually less than 10 m and desirably less than 5 m from the deposition area. In such cases where the conduit or more specifically pipeline is close to the deposition area the suspension of particulate solids should be able to flow into the deposition area.

It may be desirable in some cases to add one or both components of the treatment system, i.e. the water-soluble polymer and/or chemical agent, to the suspension of particulate solids as it exits the conduit, for instance pipeline. In other cases it may be desirable to add both components of the treatment system prior to the suspension of particulate solids exiting the outlet of the conduit, or more specifically the pipeline, for instance less than 20 m, usually less than 10 m and desirably less than 5 m from the outlet.

Suitably the dispersed particulate solids of the suspension comprise mineral solids. Typically the dispersed particulate solids are mineral. The dispersed particulate solids may for instance contain filter cake solids or tailings. Typically the suspension may be an underflow from a thickener or alternatively may be an unthickened plant waste stream. For instance, the suspension may comprise phosphates slimes, gold slimes or wastes from diamond processing. Typical suspensions of particulate solids include mineral sands tailings, zinc ore tailings, lead ore tailings, copper ore tailings, silver ore tailings, uranium ore tailings, nickel ore tailings, iron ore tailings, coal fines tailings, oil sands tailings or red mud. The suspension of particulate solids suitable for treatment in the present invention may include the concentrated suspension from the final thickener or wash stage of a mineral processing operation. Thus the suspension desirably results from a mineral processing operation. Preferably the suspension comprises tailings. Suitably the dispersed solids comprise at least some solids which are hydrophilic, for instance water swelling clays. More preferably the dispersed particulate solids are derived from tailings from a mineral sands process, coal fines tailings, oil sands tailings or red mud.

The particulate solids of the suspension will depend upon the particular material, for instance the particular type of tailings. In the case of fine tailings typically substantially all of the particles would be less than 100 μm, frequently below 50 μm, often less than 25 μm, for instance about 95% by weight of the solids being less than 20 μm and about 75% being less than 10 μm. In some cases the dispersed particulate solids have bimodal distribution of particle sizes, comprising a fine fraction and a coarse fraction, in which the fine fraction peak is less than 25 μm and a coarse fraction peak which is greater than 75 μm.

The concentration of the suspension of particulate solids will tend to vary according to the particular type of suspension. In general, the suspension of particulate solids can often be a slurry of thickened tailings, for instance a thickened tailings suspension flowing as an underflow from a thickener, for instance a gravimetric thickener, or other stirred sedimentation vessel. Suitably the suspension has a solids content in the range of from 15 to 80% by weight of total suspension. The suspension may even have a solids content in the range of from 20% to 70% by weight, for instance from 45% to 65% by weight. Preferably the solids content of the suspension of solids treated in accordance with the present invention will often be from 15 to 50%, often from 20 to 45% by weight of total suspension.

Preferably the suspension of particulate solids is an underflow stream which flows from a sedimentation vessel in which a first suspension is separated into a supernatant layer comprising an aqueous liquor and a thickened layer which is removed from the vessel as the underflow. It would be this underflow which would be subjected to the treatment according to the present invention. It would not be possible to achieve the objectives of the invention by adapting the separation in a conventional sedimentation vessel such that the thickener layer was concentrated enough to form a stack of rigidified solids. On the contrary, in order for such a highly concentrated thickened layer to be stackable the yield stress would be so high that it would be impossible to stir the thickened layer or remove the thickened layer from the conventional sedimentation vessel as an underflow. Furthermore, such solids would not be able to flow as an underflow from the vessel.

In some cases it may be desirable to add coarse particles to the underflow from the vessel. This may be done at any convenient point prior to discharge at the deposition area. Desirably the coarse particles may be added to the underflow from the vessel either before or during the addition of the treatment system. When aqueous suspensions of fine and coarse particulate solids are being combined for the purposes of co-disposal, the treatment system, comprising the water-soluble polymer and the chemical agent, should normally be added during or after the mixing of the fine and coarse particle streams. Generally such mixing of the different waste streams, in this case the fine and coarse particle streams, the resulting mixture would be a homogenous slurry.

Desirably the suspension of particulate solids to which the treatment system has been added is transferred, preferably by the action of at least one pump, along a conduit, for instance a pipeline, to an outlet of the conduit from which the suspension exits in to the deposition area. Suitably, the so treated suspension at the deposition area is allowed to separate into the liquid portion and the solids portion. In general the solids portion would have a higher yield stress than the suspension of particulate solids prior to separation. Typically the solid portion should form a layer in the deposition area.

In general as the liquid portion separates from the suspension it would flow away from the separated solids portion which would remain as a layer in the deposition area. Further suspension of particulate solids may be allowed to flow over the surface of one or more layers of previously separated solids portion followed by separation. Thus it is desirable that the solids portion forms a layer over the surface of one or more layers of previously solids portion(s).

The separation of the solids portion and liquid portion generally occurs when the flow of the suspension slows and the suspension substantially stops flowing. Suitably the solids portion would tend to form rigidified solids. Suitably, further so treated suspension of particulate solids will then be allowed to flow over the surface of the rigidified solids where the further so treated suspension would be allowed to separate into the liquid portion and solids deposit which would remain on the surface of the previously rigidified solids and also will desirably stand and rigidify. This process may be continued with the so treated suspension flowing over the surface previously layers of rigidified solids to provide a stack comprising multiple layers of rigidified solids.

The inventors have discovered that the chemical agent employed as part of the treatment system in the present invention brings about a further effect in which voids which are distributed throughout the matrix of the rigidified solids consolidate. Generally, these voids would be filled or a least contain aqueous liquid and the compression would enable a further release of aqueous liquid and further consolidation of the rigidified solids. We have found that we achieve a release of liquid that would otherwise be entrained within voids that are distributed throughout the matrix of solids due to the viscosity and surface tension of the liquid is able to flow as a result of the action of the chemical agent. The inventors have further discovered that the process of the present invention enables a more rapid consolidation of solids and also achieving higher solids content. This has the advantage that with a reduced water content the so formed solids portion of further consolidated rigidified solids would be less prone to movement or landslip. After this primary and secondary release of aqueous liquid from the so formed solids portion of further consolidated rigidified solids, any residual moisture or entrained liquid may subsequently be released by a combination of evaporation and drainage through the bed of solids.

Desirably the deposited solids portion will form a beach of further consolidated rigidified solids. The angle of the beach slope will depend upon the particular solids, for example type of tailings, deposited at the deposition area. In the case of coal tailings the angle of the beach may be quite significant, for instance having a beach slope of about 8%. In the case of suspensions of other solid particles, for instance in a hard rock application, the beach slope may be more subtle, for instance between 2 and 3% beach slope. In order to maximise the available deposition area generally it would be important to control the depositional geometry, i.e. the beach slope angle according to the substrate i.e. type of solids in suspension. The beaching angle, that is the angle of the slope of the beach, is believed to be related to the yield stress, the impact water-soluble polymer on post depositional yield stress and the influence of the chemical agent and its interaction with the water-soluble polymer after deposition. Generally the lower the yield stress the lower is the beaching angle.

The yield stress required by deposited solids will depend upon the type of suspension, for instance the type of tailings processes. For instance, in the case of oil sands Directive 074 requires that evaporative dried deposited oil sand tailings have a yield stress of at least 5 kPa. In the case of evaporative dried deposited red mud the yield stress should be at least 20 kPa in order to be sufficiently rigid support machinery.

Normally, yield stress is attributed to particle particle interaction, and effective friction angle at equivalent void ratios. Generally in a process of rigidification where polymer is added to the suspension of particulate solids as it is being transferred as a fluid a higher yield stress can be achieved more rapidly. The treatment system of the present invention involving the addition of water soluble polymer and chemical agent appear to preserve this rapid increase in yield stress but allow the rigidified predominantly solids portion to attain a higher solids content by further consolidation of the solids, compression of the void spaces and release of further aqueous fluid.

How a deposited solids consolidates may be considered in terms of the coefficient of consolidation. The coefficient of consolidation (Cv), measured in m²/sec, is the ratio of hydraulic conductivity (k), measured in m/sec, to the product of the unit weight of pore fluid (Yw), measured in kN/m³, and the ratio of volume change to the increase of effective stress (Mv), measured in m²/kN. This can be represented by the formula:

$$Cv = \frac{k}{MvYw}$$

As disclosed by Terzaghi & Peck (1967), “Consolidation Theory”

Without being limited to theory, the inventors believe that the addition of water-soluble polymers, for instance high molecular weight water-soluble polymers initially increases the hydraulic conductivity more rapidly than could be achieved in the absence of the water-soluble polymers. However, the maximum hydraulic conductivity achieved may not be as high as it would otherwise be, in the case where the particles interact in the absence of the polymer. The inventors of the present invention believe that the present process involving the treatment system which employs both water-soluble polymer and chemical agent a higher hydraulic conductivity can be achieved than the use of the water-soluble polymer alone possibly due to the chemical agent degrading the polymer and thereby reducing the viscosity of the fluid held in the voids in the matrix of the rigidified solid deposit resulting in the fluid being enabled to flow out of the matrix of rigidified solids.

Since the deposited solids are generally waste materials which are being disposed of at the deposition area, it is generally important that the deposited solids occupy as small an area as possible. The process of the present invention enables the formation of stacks of rigidified material which have the advantage that less area is required for disposal. Further, since the present process enables further consolidation of the deposited solids the resulting volume is also reduced and thereby facilitating the deposition of further solids material.

The rheological characteristics of the suspension of particulate solids so treated with the treatment system of the present invention as it flows through the conduit, for instance pipeline, to the deposition area is important, since any significant reduction in flow characteristics may seriously impair the efficiency of the process. It is important that there is no significant settling of the solids as this could result in a blockage, which may mean that the plant has to be closed in order to allow the blockage to be cleared. In addition it is important that there is no significant reduction in flow characteristics, since this could drastically impair the flowability of the suspension. Such a deleterious effect could result in significantly increased energy costs as pumping becomes harder and the likelihood of increased wear on the pumping equipment. The addition of the chemical agent and the water-soluble polymer to the suspension in the present invention has been found not to exhibit disadvantageous flow characteristics by comparison to the addition of water-soluble polymer in the absence of the chemical agent.

The rheological characteristics of the suspension as it is rigidified is important, since once the so treated suspension is allowed to stand it is important that flow is minimised and that the separation of the solid particles from the liquid proceeds rapidly to allow deposition of the rigidified solids portion then further consolidation of the rigidified solids portion. If the so treated suspension has a too high a fluidity, for instance if the solids content of the suspension of particulate solids to be treated is too low, this may impair the ability to form an effective stack of rigidified solids and also that the liquid portion separated does not contain an acceptably high level of solids. In addition it is also necessary that the rigidified deposited solids has sufficient strength to remain largely intact with reduced lateral mobility and withstand the weight of subsequent layers of treated suspension being applied to it.

Preferably the process of the invention will achieve a heaped disposal geometry and will co-immobilise the fine and any coarse fractions of the solids in the suspension and also allowing any released water to have a higher driving force to separate it from the suspension by virtue of hydraulic gravity drainage. The heaped geometry appears to give a higher downward compaction pressure on underlying solids which seems to be responsible for enhancing the rate of dewatering. We find that this geometry results in a higher volume of waste per surface area, which is both environmentally and economically beneficial.

A preferred feature of the present invention is the release of aqueous liquor that often occurs during the rigidification step. Thus in a preferred form of the invention the suspension is dewatered during rigidification to initial release of liquor and the subsequent release of liquor from the rigidified solids in which the liquor containing significantly less solids. Where the process of the present invention is treating a suspension resulting from an industrial process, for instance a mineral processing operation, the liquor can then be returned to that industrial process thus reducing the volume of imported water required and therefore it is important that the liquor is clear and substantially free of contaminants, especially migrating particulate fines. Suitably the liquor may for instance be recycled to the mining operation, for instance oil sands operation, from which the suspension originates. Alternatively, the liquor can be recycled to the spirals or other processes within the same plant.

The following examples illustrate, but do not limit, the invention.

### EXAMPLE 1

A slurry of coal tailings is provided from the underflow of a thickener vessel of a coal processing operation.

The slurry of coal tailings is flowed along a conduit towards a deposition zone. An aqueous solution of an anionic polyacrylamide at a concentration of 0.5% is dosed into the flowing slurry at a dose of 350 grams per tonne (active polymer on dry solids of the slurry) about 12 m from the deposition zone end of the conduit. 2 m after the polymer is dosed into the flowing slurry a hydrogen peroxide solution at 30% concentration is dosed into the flowing slurry at a dose to provide a ratio of polymer to hydrogen peroxide of 1:65.

On exiting the conduit at the deposition zone, the so treated mineral sands slurry pours onto a beach in the deposition zone where the flow of the solids ceases and liquid component of the slurry quickly flows from the deposited solids. A reduction in the volume of tailings deposited is accompanied by increased solids density, increased hydraulic conductivity and increase yield stress over a period of several weeks from three hours after deposition.

### EXAMPLE 2

A slurry of mineral sands tailings is provided from the underflow of a thickener vessel of a mineral sands processing operation. The solids content of the slurry is typically between 50 and 55% (wt/wt) of which, between 10 and 12% (wt/wt) have a particle size of less than 75 μm. Typically, the specific gravity is in the region of about 1.5 g/cm³.

The slurry of mineral sands tailings is flowed along a conduit towards any depositions zone. At 5 m from the depositions zone end of the conduit an aqueous solution of an anionic polyacrylamide at a concentration of 0.05% w/v is dosed into the flowing slurry at a dose of 50 g per tonne (active polymer on dry solids of the slurry) at the same time as dosing into the slurry an aqueous solution of hydrogen peroxide (at a concentration of 30%). The ratio of polymer to hydrogen peroxide added to the slurry is 1:50.

The so treated mineral sands slurry exits the conduit at the depositions zone onto a surface where the flow of the solids stops and the liquid component of the slurry quickly flows from the deposited solids. A reduction in the body of tailings deposited is accompanied by increased solids density, increased hydraulic conductivity and increase yield stress over a period of several weeks from three hours from deposition.

1. A process of separating a suspension comprising particulate solids dispersed in an aqueous liquid into a liquid portion and a solids portion comprising transferring the suspension by flowing it to a deposition area, subjecting the suspension to a treatment system during the transfer, and at the deposition area allowing the suspension to separate into the liquid portion and the solids portion,
wherein the treatment system comprises,
(a) a water soluble polymer; and
(b) a chemical agent selected from at least one of an oxidising agent, a reducing agent, and/or a free radical agent.

2. The process according to claim 1 in which the water soluble polymer is formed from at least one ethylenically unsaturated water-soluble monomer.

3. The process according to claim 1 in which the water-soluble polymer is formed from at least one monomer selected from the group consisting of (meth) acrylic acid (or a salt thereof), allyl sulphonic acid (or a salt thereof), and 2-acrylamido-2-methyl propane sulphonic acid (or a salt thereof), optionally in combination with at least one comonomer selected from the group consisting of (meth) acrylamide, hydroxy alkyl esters of (meth) acrylic acid, N-vinyl pyrrolidone, vinyl amides, and vinyl carboxylates.

4. The process according to claim 1 in which the water soluble polymer is formed from at least one monomer selected from the group consisting of (meth) acrylamide, hydroxy alkyl esters of (meth) acrylic acid, N-vinyl pyrrolidone, vinyl amides, and vinyl carboxylates.

5. The process according to claim 1 in which the water soluble polymer is formed from at least one monomer selected from the group consisting of dimethyl amino ethyl (meth) acrylate-methyl chloride, (DMAEA.MeCl) quat, diallyl dimethyl ammonium chloride (DADMAC), trimethyl amino propyl (meth) acrylamide chloride (ATPAC) optionally in combination with non-ionic co-monomers, selected from the group consisting of (meth) acrylamide, hydroxy alkyl esters of (meth) acrylic acid, N-vinyl pyrrolidone, vinyl amides, and vinyl carboxylates.

6. The process according to claim 1 in which the water soluble polymer is added to the suspension in the form of an aqueous solution.

7. The process according to claim 1 in which the chemical agent is selected from the group consisting of peroxides, ozone, hypochlorites, peracetates, perborates, percarbonates, persulphates, bromates, bisulphites, sulphites, ferrous ammonium sulphate, ammonium persulphate, and ceric ammonium nitrate.

8. The process according to claim 1 in which the water soluble polymer and the chemical agent are both added to the suspension substantially simultaneously.

9. The process according to claim 1 in which the water soluble polymer and the chemical agent are both added to the suspension after a pumping stage.

10. The process according to claim 1 in which the dispersed particulate solids are mineral.

11. The process according to claim 1 in which the dispersed particulate solids are derived from tailings from a mineral sands process, coal fines tailings, oil sands tailings, or red mud.

12. The process according to claim 1 in which the dispersed particulate solids have particles sizes less than 100 μm.

13. The process according to claim 1 in which the dispersed particulate solids have a bimodal distribution of particle sizes comprising a fine fraction and a coarse fraction, in which the fine fraction peak is less than 25 μm and a coarse fraction peak is greater than 75 μm.

14. The process according to claim 1 in which the suspension has a solids content in the range of 15% to 80% by weight of total suspension.

15. The process according to claim 1 in which the suspension is an underflow stream which flows from a sedimentation vessel in which a first suspension is separated into a supernatant layer comprising an aqueous liquor and a thickened layer which is removed from the vessel as the underflow.

16. The process according to claim 1 in which the suspension is transferred along a conduit employing at least one pump to an outlet of the conduit from which the suspension exits into the deposition area.

17. The process according to claim 15 in which coarse particles are added to the underflow from the vessel either before or during the addition of the treatment system.

18. The process according to claim 1 in which the suspension is transferred to a holding vessel before being pumped to the deposition area.

19. The process according to claim 1 in which the solids portion forms a layer in the deposition area.

20. The process according to claim 1 in which the liquid portion which separates from the suspension in the deposition area flows away from the separated solids portion which remains as a layer in the deposition area.

21. The process according to claim 1 in which the solids portion has a higher yield stress than the suspension prior to separation.

22. The process according to claim 1 in which the solids portion forms a layer over the surface of one or more layers of previously solids portion.

23. The process according to claim 1 in which the solids portion is formed by an initial release of liquid and rigidification of the solids followed by a subsequent consolidation of the rigidified solids with further release of liquid.

24. The process according to claim 22 in which the layers of the solids portion forms a stack comprising multiple layers of the solids portion in which each layer of solids portion is formed by an initial release of liquid and rigidification of the solids and in which a subsequent consolidation of each layer of solids occurs with further release of liquid.
